(19) United States
(12) Patent Application Publication
(10) Pub. No.: US 2010/0074543 A1
(43) Pub. Date: Mar. 25, 2010

(54) Image Compression Apparatus and Image Expansion Apparatus

(76) Inventor: Atsushi Torai, Tokyo (JP)

Correspondence Address: SQUIRE, SANDERS & DEMPSEY L.L.P., 1 MARITIME PLAZA, SUITE 300, SAN FRANCISCO, CA, 94111, US

(21) Appl. No.: 12/553,722

(22) Filed: Sep. 3, 2009

(30) Foreign Application Priority Data
Sep. 19, 2008 (JP) JP2008-241738

(51) Int. Cl. G06K 9/36

(52) U.S. Cl. 382/239

(57) ABSTRACT

An image compression apparatus comprising, a dividing section for dividing image data to be compressed into a plurality of blocks, a compression section for compressing in order each block of the plurality of blocks which have been obtained by divided in the dividing section, wherein the compression section converts the continuing blocks of the same image contents, into basic data and continuous compressed data, wherein the basic data is a compressed date from any one of the continuing blocks of the same image contents, and the count data indicates a number of the continuing blocks.

### RELATED APPLICATION

This application claims priority from Japanese patent application No. 2008-241738 filed with Japan Patent Office on Sep. 19, 2008, which is incorporated hereinto by reference.

### TECHNICAL FIELD

The present invention relates to an image compression apparatus for compressing image data and an image expansion apparatus for expanding the compressed data. The present invention particularly relates to an image compression apparatus and an image expansion apparatus for dividing an image into a plurality of blocks and for compressing and expanding the image.

With respect to an apparatus, such as a digital multi function peripheral, in case when storing image data of bit map form into a memory or a hard disk drive, the image data is compressed and stored in order to reduce a required storage capacity.

There is a BTC (Block Truncation Coding) compression technology as one of the compression technologies. With respect to the BTC compression, an image to be compressed is divided into blocks for every predetermined number of pixels (for example, 4 pixels×4 pixels). The compressed data in which each block is expressed with information (for example, the maximum value and the minimum value), which indicates a distribution range of a gradation values of the pixels that belong to the block, and with code data, in which the gradation value of each pixel in the block in the distribution range is normalized with the gradation smaller than the gradation of the original image data, is generated.

At the time of an expansion, a representative value for each value of the code data is determined from the distribution range of the gradation value indicated by the maximum value and the minimum value included in the compressed data. Each of the code data included in the compressed data is converted into the image data of the corresponding representative value, and the image is restored.

FIG. 12 illustrates a block diagram showing an example of a compression expansion circuit 200 of the BTC method conventionally used. The compression expansion circuit 200 is configured by a compression circuit section 210 and an expansion circuit section 230 by which the compressed image data generated by this compression circuit section 210 is expanded.

The compression circuit section 210 is configured by a block dividing section 211, a maximum value and minimum value retrieval section 212, a threshold value generation section 213 and a normalization section 214. The block dividing section 211 divides the inputted image data to be compressed into blocks for every predetermined number of pixels (for example, 4 pixels×4 pixels). The maximum value and minimum value retrieval section 212 calculates the maximum value and the minimum value of a pixel value (gradation value) of the pixel that belongs to the block for every block after dividing the input data.

The threshold value generation section 213 generates threshold values (first, second and third threshold values) for dividing the range having the maximum value and the minimum value that have been calculated by the maximum value and minimum value retrieval section 212, the maximum value and the minimum value being both ends of the range respectively into predetermined N areas (for example, “4”). Then the threshold value generation section 213 outputs these threshold values to the normalization section 214. The normalization section 214 generates the code data (normalized data) that indicates where in the N areas, each pixel in the block belongs to based on the threshold values inputted from the threshold value generation section 213. Then the normalization section 214 outputs the compressed image data configured by the maximum value, the minimum value and the code data.

The expansion circuit section 230 is configured by a comparison determination section 231, a representative value generation section 232 and a representative value replacing section 233. The comparison determination section 231 compares the maximum value and the minimum value, which are included in the compressed image data, and outputs the signal that indicates the maximum value, the minimum value and a normalization bit number to the representative value generation section 232. Based on the signal, the representative value generation section 232 computes the representative value of the pixel value (gradation value) that corresponds to each value of the code data. The representative value replacing section 233 converts and outputs each of the code data included in the compressed image data into the image data of the representative value corresponding to the value of the code data.

FIG. 13 illustrates an example of a compression of image data, and FIG. 14 illustrates an example of an expansion of the compressed image data. In this example, the BTC compression with the code data of 2-bit (four gradation) per pixel is performed to original image data 250 for one block of 4 pixels×4 pixels in which each pixel is expressed in 8-bit 256 gradations (in the drawing, the gradation value is expressed in hexadecimal number).

As illustrated in FIG. 13a, at the time of the compression, a maximum value FFh and a minimum value 00h of the gradation value within the block are detected. The distribution range having these values at both ends is divided into four areas. A gradation value D is normalized (coded) so that a pixel having the maximum value (FFh)≧D>a threshold value 3 (C0h) will become 2-bit code data “11”, a pixel having the threshold value 3 (C0h)≧D>a threshold value 2 (80h) will become code data “10”, a pixel having the threshold value 2 (80h)≧D>a threshold value 1 (40h) will become code data “01” and a pixel having the threshold value 1 (40h)≧D>the minimum value (00h) will become code data “00”. Compressed data 251 is configured by the code data (32 bits) for these 16 pixels and data that indicates the maximum value FFh (8 bits) and the minimum value Oh (8 bits). The volume of the data is 6 bytes (48 bits). The compressed image data is arranged in order of the maximum value, the minimum value and the code data, as illustrated in FIG. 13b.

As illustrated in FIG. 14, at the time of an expansion, a pixel value (representative value) corresponding to the value of each code data is calculated from the data that indicates the maximum value, the minimum value and the number of normalization bits. That is, for example, in case when the maximum value is set to FFh and the minimum value is set to 00h, the maximum value FFh is set to a representative value 4 corresponding to the code data “11”, the minimum value 00h is set to a representative value 1 corresponding to the code data “00”, the larger AAh of two boundary values that divide the range that expresses this maximum value and the minimum value into three areas is set to a representative value 3 corresponding to the code data “10”, and the smaller 55h of the two boundary values is set to a representative value 2 corresponding to the code data “01”. The data is converted into expansion data 252 for one block by converting each code data included in the compressed data 251 into the representative value corresponding to the value of the code data.

As illustrated in FIG. 15, in this compression/expansion method, even in case when the gradation values (pixel value) of all pixels within the block are the same (in this example, all pixels are FFh), the data volume of the compressed image data for one block becomes 48 bits that is the same with the case in which the image data 250 is compressed as the example of FIG. 13 illustrates. FIG. 15 illustrates each image data of before the compression, at the time of compression and of after the expansion. FIG. 15b also illustrates an arrangement of the compressed image data.

With respect to an image processing apparatus to which an improvement for increasing the compression efficiency in case when the same image data continues has been performed, for example, there is an apparatus in which the compressed data of two continuous blocks are compared per byte, a flag sequence that illustrates the same section of the compressed data with “0” and the different section with “1” is provided, and a secondary compression that omits data of a section that corresponds to the section where the flag is “0” is performed (for example, refer to a patent document Unexamined Japanese Patent Application Publication No. 2007-43577).

In the compression method disclosed in Unexamined Japanese Patent Application Publication No. 2007-43577, the compressed data and compressed data one before the compressed data are compared and the secondary compression is performed to the compressed data. Therefore, since the flag sequence for the number of byte of the compressed data is added by the secondary compression even when exactly the same compressed data continues many times, there has been a problem that the compression rate was not efficient enough

The present invention solves the above mentioned problem. An object of the present invention is to provide an image compression apparatus, in which the compression rate increases in case when blocks of the same image contents continue when an image is divided and compressed into a plurality of blocks, and to provide an image expansion apparatus, which corresponds to the image compression apparatus.

### SUMMARY

The aspects of the present invention are any one of the image forming apparatus described as follows.

[1] An image compression apparatus including, a dividing section for dividing image data to be compressed into a plurality of blocks, a compression section for compressing in order each block of the plurality of blocks which have been obtained by divided in the dividing section, wherein the compression section converts the continuing blocks of the same image contents, into basic data and continuous compressed data, wherein the basic data is a compressed date from any one of the continuing blocks of the same image contents, and the count data indicates a number of the continuing blocks.

In the above mentioned invention, the blocks in which the same image contents continue are compressed into compression data configured by data, into which any one of the blocks (for example, the foremost block of the continuous block) is compressed as a bunch, and data, which indicates the number of the continuous block.

[2] An image expansion apparatus expanding compressed data which has been compressed in order each block of a plurality of blocks obtained by dividing image data, and which has been converted into continuous compressed data containing a basic data which is a compressed date from any one of continuing blocks of the same image contents and a count data indicating a number of continuing blocks, and including, a detection section detecting the continuous compressed data, a repeat output section expanding the basic data of the continuous compressed data detected by the detecting section into one block of image data, and repeating output of the one block of the image data the same number of times as the number of the continuing blocks indicated by the count data.

In the above mentioned invention, expansion corresponding to the compressed image data which compressed by the image compression apparatus [1] is done.

According to the image compression apparatus pertaining to the present invention, when dividing an image into a plurality of blocks and compressing the blocks, a compression rate of a case in which blocks having the same image contents continue can be increased. According to the image expansion apparatus pertaining to the present invention, the compressed image data compressed in such way can be expanded.

### BRIEF DESCRIPTION OF THE DRAWINGS

FIG. 1 illustrates a block diagram showing an outline configuration of an image compression apparatus pertaining to an embodiment of the present invention.

FIG. 2 illustrates an explanatory diagram simulatively showing a state in which an image to be compressed is divided into blocks.

FIG. 3a illustrates an explanatory diagram showing data formats of compressed data for every block.

FIG. 3b illustrates an explanatory diagram showing a continuous compressed data.

FIG. 4 illustrates an explanatory diagram showing an example of data and a data format for variable length count data.

FIG. 5 illustrates a block diagram showing an outline configuration of an image expansion apparatus pertaining to the embodiment of the present invention.

FIG. 6a illustrates an explanatory diagram showing a case in which an image A is compressed into compressed data for every block and expanded by the image compression apparatus and the image expansion apparatus pertaining to the embodiment of the present invention, respectively.

FIG. 6b illustrates an explanatory diagram showing a compressed image data.

FIG. 7 illustrates an explanatory diagram showing a case in which an image B is compressed into continuous compressed data (one continuous block) and expanded by the image compression apparatus and the image expansion apparatus pertaining to the embodiment of the present invention, respectively.

FIG. 8 illustrates an explanatory diagram showing a case in which an image C is compressed into continuous compressed data (ten continuous blocks) and expanded by the image compression apparatus and the image expansion apparatus pertaining to the embodiment of the present invention, respectively.

FIG. 9 illustrates an explanatory diagram showing a case in which an image D is compressed into continuous compressed data (260 continuous blocks) and expanded by the image compression apparatus and the image expansion apparatus pertaining to the embodiment of the present invention, respectively.

FIG. 10 illustrates a flow chart showing a flow of a compression process in the image compression apparatus pertaining to the embodiment of the present invention.

FIG. 11 illustrates a flow chart showing a flow of an expansion process in the image expansion apparatus pertaining to the embodiment of the present invention.

FIG. 12 illustrates a block diagram showing a compression expansion circuit of the conventional BTC method.

FIG. 13a illustrates an explanatory diagram showing an example of a compression of the image data based on the compression expansion circuit of the conventional BTC method.

FIG. 13b illustrates an explanatory diagram showing a compressed image data by the conventional BTC method.

FIG. 14 illustrates an explanatory diagram showing an example of an expansion of the image data based on the compression expansion circuit of the conventional BTC method.

FIG. 15a illustrates an explanatory diagram showing an example of a compression expansion of a block, in which all pixels have the same pixel value, by the compression expansion circuit of the conventional BTC method.

FIG. 15b illustrates an explanatory diagram showing a compressed image data by the conventional BTC method.

### DESCRIPTION OF THE PREFERRED EMBODIMENT

Hereafter, an embodiment of the present invention will be described in reference to the drawings.

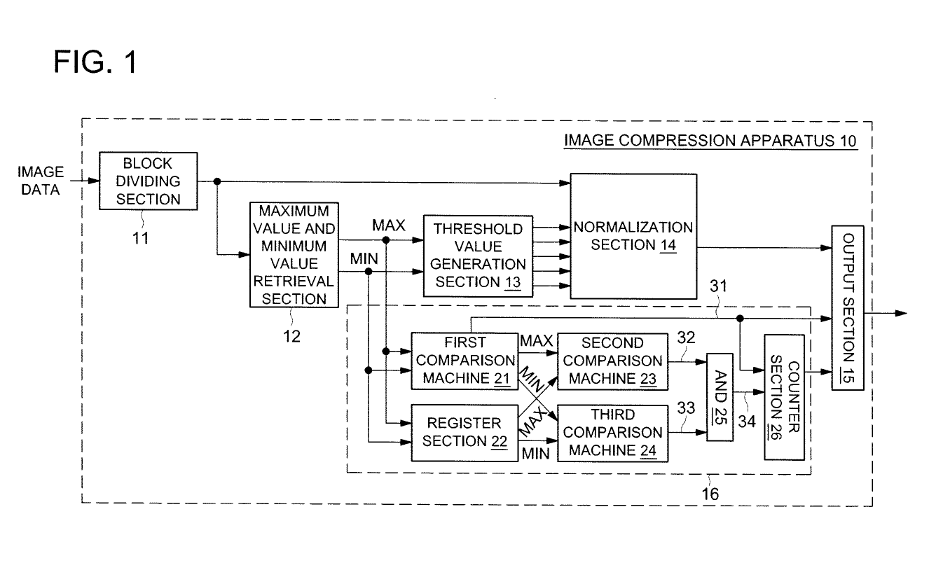

FIG. 1 illustrates a configuration of an image compression apparatus 10 pertaining to an embodiment of the present invention. For example, the image compression apparatus 10 is used in case when image data is compressed and stored in a hard disk drive in a multi function peripheral provided with a copy function and a print function of a document. The image compression apparatus 10 is configured by a hardware circuitry into which a micro program is built in, such as a sequencer and a logic circuit.

A compression method used in the image compression apparatus 10 is based on the BTC compression. For example, the image data to be inputted is image data of bit map format in which one pixel is expressed in 256 gradations of 8-bit deep.

The image compression apparatus 10 is configured by a block dividing section 11, a maximum value and minimum value retrieval section 12, a threshold value generation section 13, a normalization section 14, an output section 15 and a continuous compression section 16.

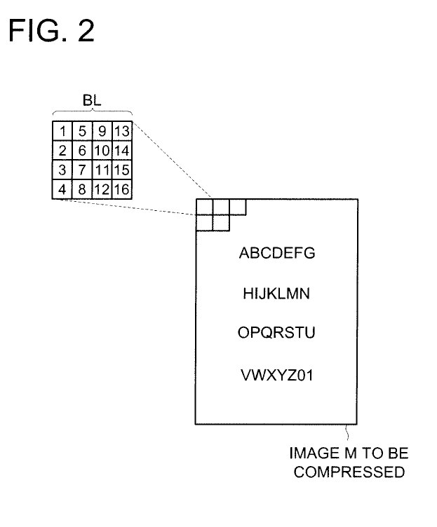

The block dividing section 11 divides the inputted image data to be compressed into blocks for every predetermined number of pixels. Here, as illustrated in FIG. 2, the image data is divided into a block (4 pixels×4 pixels) BL starting at the upper left of an image M. The block dividing section 11 sends out the divided blocks to the maximum value and minimum value retrieval section 12 and the normalization section 14 one after another.

The maximum value and minimum value retrieval section 12 calculates the maximum value and the minimum value of a pixel value (gradation value) of a pixel that belongs to the block for every block divided and obtained by the block dividing section 11. For example, the maximum value and the minimum value of the pixel value in the block are detected by comparing the pixel value of each pixel in the block one after another. The detected result is inputted into the threshold value generation section 13 and the continuous compression section 16.

The threshold value generation section 13 generates a threshold value for N−1 area for dividing (here divided into equal parts) the distribution range of the pixel value having the maximum value and the minimum value inputted from the maximum value and minimum value retrieval section 12 at both ends into N areas (N is two or larger integer). The threshold value generation section 13 outputs the maximum value, the minimum value and these threshold values for N−1 areas to the normalization section 14. Here, N is set to “4”. The maximum value (Max), a third threshold value, a second threshold value, a first threshold value and the minimum value (Min) are outputted to the normalization section 14 from the threshold value generation section 13. The relation of these values is the maximum value (Max)>the third threshold value>the second threshold value>the first threshold value>the minimum value (Min).

The normalization section 14 generates the code data, which indicates where each pixel within the block belongs to in N areas based on the threshold value inputted from the threshold value generation 13. The normalization section 14 generates the compressed image data, which is arranged in the order of the maximum value, the minimum value and the code data for number of pixels. Here, since N is set to “4”, the bit number of the code data per pixel is 2 bits, which is the minimum number of pixels that is capable of expressing four areas. The pixel value D is converted to the code data so that a pixel having the maximum value≧D>threshold value 3 becomes “11”, a pixel having the threshold value 3≧D>threshold value 2 becomes “10”, a pixel having threshold value 2≧D>threshold value 1 becomes “01”, and a pixel having the threshold value 1 (40h)≧D≧the minimum value becomes “00”. The code data are arranged in the numeric order given to each pixel within the block BL of FIG. 2.

In case when blocks of the same image content continue, the continuous compression section 16 converts these continuous blocks into the compressed data (continuous compressed data) that includes the data (basic data), in which any one of theses blocks is compressed, and the counter data, which indicates number of continuous blocks. Here, the continuous block, in which the pixel values of all pixels within the block are the same and the pixel values of the blocks are the same, is detected as a plurality of blocks in which the same image contents is continuous. That is, in case when the block in which all pixels within the block has the same pixel values (maximum value=minimum value), the number of continuation (number of continuous blocks) of the block having this maximum value and minimum value is counted. The continuous compression section 16 converts these continuous blocks into the continuous compressed data as one bunch. Under the present circumstance, even in case when the number of continuous block in which all pixels within the block have the same pixel values, the block is compressed with the continuous compressed data form.

In detail, the continuous compression section 16 is configured by a first comparison machine 21, a register section 22, a second comparison machine 23, a third comparison machine 24, an AND circuit 25 and a counter section 26. The first comparison machine 21 compares the maximum value and the minimum value, which have been inputted from the maximum value and minimum value retrieval section 12. The first comparison machine 21 outputs a first coincidence signal that becomes “1” (logically true) in case when the maximum value and the minimum value are equal to each other. The first comparison machine 21 determines that the pixel values of all pixels within the block are the same when the maximum value and the minimum value are equal to each other. The first comparison machine 21 outputs the maximum value and the minimum value, which were inputted, to a latter comparison machine without any change.

The register section 22 holds the maximum value and the minimum value, which were inputted from the maximum value and minimum value retrieval section 12, delays the held maximum value and the minimum value for one block and outputs the maximum value and the minimum value. Namely, the register section 22 outputs the maximum value and the minimum value at the timing of when the maximum value and the minimum value of the next block is inputted from the maximum value and minimum value retrieval section 12.

The second comparison machine 23 compares the maximum value inputted from the first comparison machine 21 and the maximum value of the block one before the present block inputted from the register section 22. The second comparison machine 23 outputs a second coincidence signal 32, which becomes “1” (logically true) in case when these maximum values are equal to each other, to one of the inputs of the AND circuit 25. That is, the second comparison 23 outputs the second coincidence signal 32 that becomes “1” in case when the maximum value of the present block and the maximum value of the block one before the present block are equal to each other.

The third comparison machine 24 compares the minimum value inputted from the first comparison machine 21 and the minimum value of the block one before the present block inputted from the register section 22. The third comparison machine 24 outputs the third coincidence signal 33, which becomes “1” (logically true) in case when these minimum values are equal to each other, to the other input of the AND circuit 25. That is, the third comparison machine 24 outputs the third coincidence signal 33 that becomes “1” in case when the minimum value of the present block and the minimum value of the block one before the present block are equal to each other.

The first coincidence signal 31 and an output signal 34 of the AND circuit 25 are inputted into the counter section 26. The counter section 26 counts the number of times when the output signal 34 becomes “1” (logically true) and the first coincidence signal 31 becomes “1”. A case in which the value of the first coincidence signal 31 is “1” indicates that the maximum value and the minimum value of the present block are equal to each other. A case in which the output signal 34 of the AND circuit 25 is “1” indicates that the maximum value of the present block and the maximum value of the block one before the present block are equal to each other, and the minimum value of the present block and the minimum value of the block one before the present block are equal to each other. Therefore, by counting the number of times when the output signal 34 is “1” and the first coincidence signal 31 is “1”, the number of times when the maximum value and the minimum value of the present block are equal to each other and the block having those maximum value and minimum value continues is counted (the number of continuous block).

The continuous compression section 16 operates based on a unit of one block input. For example, a sequencer that is un-illustrated generates a pulse signal every time the image data for one block is inputted. This pulse signal operates as a clock. In case when the output signal 34 is “0” and the first coincidence signal 31 is “1”, a first block of the block having the same maximum value and the minimum value is detected. Therefore, at this time, the value of the number counted by the counter section 26 is initialized to “1”. In case when the same contents continues for the following block, the first coincidence signal 31 is “1” and the output signal 34 is “1”. Thus, one is added to the value of the number counted by the counter section 26 and the value of the counted number becomes “2”.

That is, since a block having the same maximum value and minimum value is recognized as the first block and blocks having the same image contents continue while the block continues to be in a state in which the first coincidence signal 31 is “1” and the output signal 34 is “1”, the number of those blocks is counted. In case when the state of the block changes to a state in which the first coincidence signal 31 is “1” and the output signal 34 is “0” (the first coincidence signal 31=“0”, or the first coincidence signal 31=“1” and the output signal 34=“0”), the continuation of the block having the same image contents stops one block before the block having the first coincidence signal 31 as “1” and the output signal 34 as “0” (one block before is the last block of the continuous block).

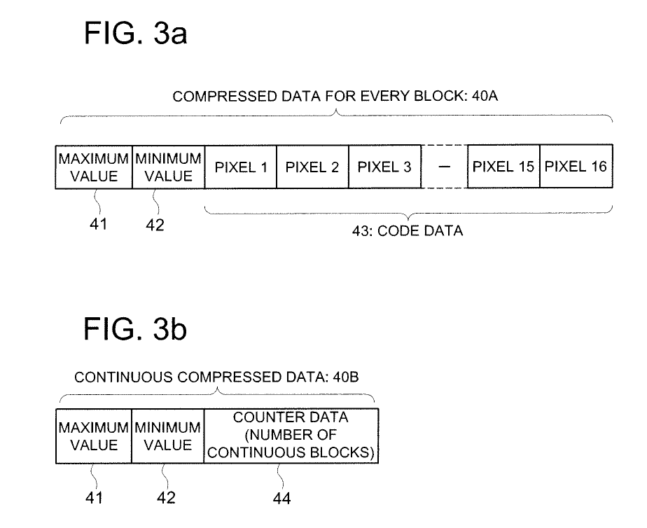

With respect to the block in which the first coincidence signal 31 is “0”, the output section 15 outputs the compressed image data outputted from the normalization section 14. That is, as illustrated in FIG. 3a, the compressed image data in a block unit configured by data 41 that indicates the maximum value, data 42 that indicates the minimum value and code data 43 for one block (this data is called compressed data for every block 40A). On the other hand, the number of continuous blocks is counted in case when the first coincidence signal 31 is “1”. As illustrated in FIG. 3b, the compressed image data (this is called continuous compressed data 40B) configured by the data 41 that indicates the maximum value, the data 42 that indicates the minimum value 42 and data that indicates the number of continuous blocks (count data 44) is outputted.

The count data 44 is a value of the number counted by the counter section 26 until just before the continuation of the block stops. In the continuous compressed data, an image contents for one block is expressed with the data that indicates the maximum value and the data that indicates the minimum value. That is, since the maximum value=the minimum value, it is indicated that all of the pixels within one block have the maximum value as the pixel value. The count data 44 expresses how many times the blocks having the same image as the image for one block continue.

In case when the image contents of the block (the maximum value=the minimum value) having the same pixel value as all pixels within the block are not the same with the blocks before and after, the block is compressed with the continuous compressed data format as the number of continuous block=1. The reason for this is to use the condition of the maximum value=the minimum value as information that indicates that the data format of the compressed image data is the continuous compressed data 40.

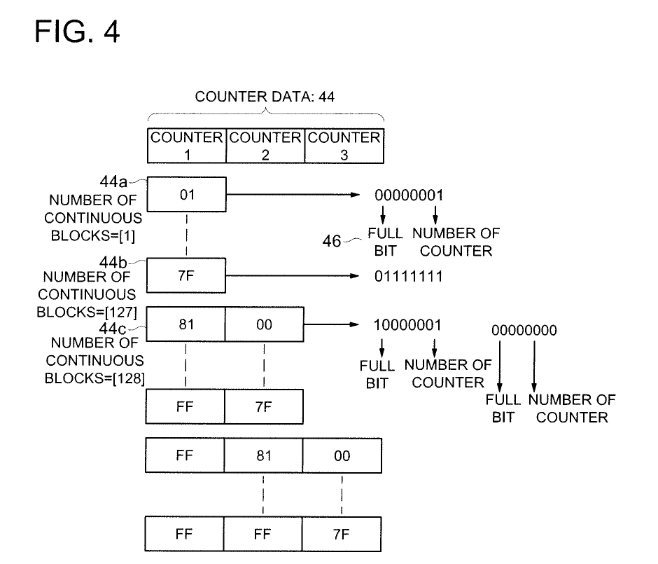

According to the embodiment of the present invention, the count data 44 is arranged to be a variable length. FIG. 4 illustrates the data structure of the count data 44. The count data 44 is configured by one or a plurality of bytes. The most significant bit of each byte is set to Fullbit 46 that indicates whether that byte is the last byte or not. The first to the seventh bits indicate the count value. The last byte of the Fullbit 46 is illustrated with “0”. The count number “1” in the higher byte of the count data is equivalent to “maximum value+1” of the count value of the lower byte. For example, in the drawing, the count data 44a indicates the number of continuous block as “1”, the count data 44b indicates the number of continuous block as “127” and the count data 44c indicates the number of continuous block as “128”.

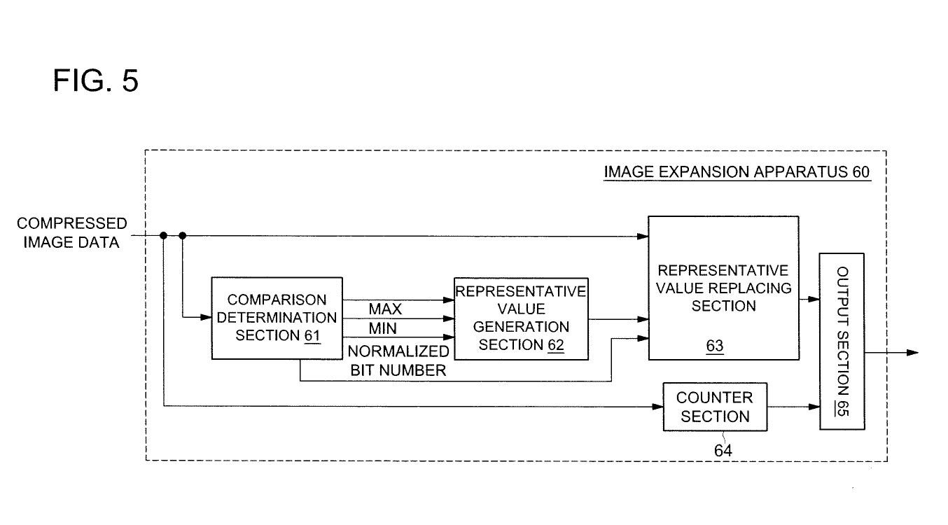

FIG. 5 illustrates a configuration of the image expansion apparatus 60. The image expansion apparatus 60 is configured by a hardware circuit, such as a logic circuit and a sequencer into which a micro program is built in. The image expansion apparatus 60 expands and converts the compressed image data outputted by the image compression apparatus 10 into image data. The image expansion apparatus 60 is configured by a comparison determination section 61, a representative value generation section 62, a representative value replacing section 63, a counter section 64 and an output section 65.

With respect to the compressed data for every block 40A, the image expansion apparatus 60 expands the image data for one block based on the maximum value data 41, the minimum value data 42 and the code data 43. In case when the continuous compressed data 40B is detected, the image expansion apparatus 60 generates the image data for one block (the image data for one block in which the pixel value of all pixels becomes the maximum value) based on the maximum value data 41 and the minimum value data 42 of the continuous compressed data 40B. Then the image expansion apparatus 60 repeats the output of the image data for one block for the same number of times as the number of continuous block indicated by the count data 44. Thus, the image data for number of continuous block is expanded.

In case when the maximum value data 41 and the minimum value data 42 arranged in the foremost of the compressed image data are different, the image expansion apparatus 60 recognizes the data as the compressed data for every block 40A and grasps a partition of the data pertaining to the following block. In case when the maximum value data 41 and the minimum value data 42 are the same, the image expansion apparatus 60 recognizes the data as the continuous compressed data 40B and grasps the end of the continuous compressed data 40B (a partition between the data pertaining to the following block).

The comparison determination section 61 compares the data 41, which indicates the maximum value, and the data 42, which indicates the minimum value, that are arranged in the foremost section of the inputted compressed image data. Then the comparison determination section 61 determines whether this compressed image data is the compressed data for every block 40A or the continuous compressed data 40B. Then the detected maximum value and minimum value and the signal that indicates a predetermined number of normalized bit (here two bits) are outputted to the representative value generation section 62.

Based on these, the representative value generation section 62 computes a representative value that is the pixel value (gradation value) that corresponds to each value of the code data. For example, the representative value generation section 62 sets each boundary value at the time of equally dividing the area between these maximum value and the minimum value into number of areas from which one has been subtracted from the number of information (for example, in case when the number of normalized bit is 2 bit, then the number of information becomes “4”) that is capable of expressing with the specified number of normalized bits to the representative value, respectively. In case when the maximum value is FFh, the minimum value is 00h and the number of normalized bit is 2, the representative value becomes the fourth representative value (FFh) that is equivalent to the maximum value, the third representative value (C0h) that is minimum value+(maximum value+minimum value)/3×2, the second representative value (55h) that is minimum value+(maximum value+minimum value)/3 and the first representative value (00h) that is equivalent to the minimum value.

The representative value replacing section 63 receives the information that indicates whether the data is the compressed data for every block 40A or the continuous compressed data 40B from the comparison determination section 61. In case when the information indicates the compressed data for every block 40A, the code data of each pixel included in the data is converted to the image data of the representative value corresponding to the value of the code data. Here, code data “00” is converted to the first representative value (in the above mentioned example, “00h”), code data “01” is converted to the second representative value (in the above mentioned example, “55h”), code data “10” is converted to the third representative value (in the above mentioned example, “C0h”) and code data “11” is converted to the fourth representative value (in the above mentioned example, “FFh”), respectively.

The code data included in the compressed data for every block 40A is converted to the pixel values in the order from the foremost of the code data, is arranged in the order of the number within the block BL in FIG. 2, and is expanded into the image data for one block. The correspondence relation between the arrangement of the pixel within one block and the arrangement within the code data is not limited to the order illustrated in FIG. 2. As long as the order is fixed between the image compression apparatus 10 and the image expansion apparatus 60, an arbitrary arrangement order may be possible.

In case when the compressed image data to be expanded is the continuous compressed data 40B, the representative value replacing section 63 generates the image data for one block having the pixel values of all pixels within the block as a value (the maximum value) that is indicated by the data 41 of the foremost of the data.

The counter section 64 receives the information that indicates whether the data is the compressed data for every block 40A or the continuous compressed data 40B from the comparison determination section 61. In case when it is determined to be the continuous compressed data 40B, the value that is indicated by the count data 44 is loaded as the initial value of the value of the counted number. Then the value of the counted number decreases every time when the image data for one block is outputted from the output section 65.

In case when the value of the counted number of the count section 64 is “0”, the output section 65 outputs the image data (expanded compressed data for every block 40A) outputted from the representative value replacing section 63. In case when the value of the number counted by the count section 64 is a value, which changed from “0” to not less than “1” (at the time of above mentioned loading), after the change, the output section 65 repeatedly outputs the data (image data for one block having the maximum value data 41 of the continuous compressed data 40B as the pixel value for all pixels) for one block outputted from the representative value replacing section 63 until the value of the counted number of the count section 64 becomes “0”. That is, in case when the loaded value (value of the count data 44) is “N”, the image data of the same value is outputted for N blocks.

Next, an example of the compression and the expansion by the image compression apparatus 10 and the image expansion apparatus 60 will be described. Here, each pixel is expressed with 8-bit 256 gradations. One block is a rectangle of 4 pixels×4 pixels. The number of normalized bit of each pixel is 2 bits. In the drawing, the pixel value, the threshold value and the representative value are expressed in the hexadecimal.

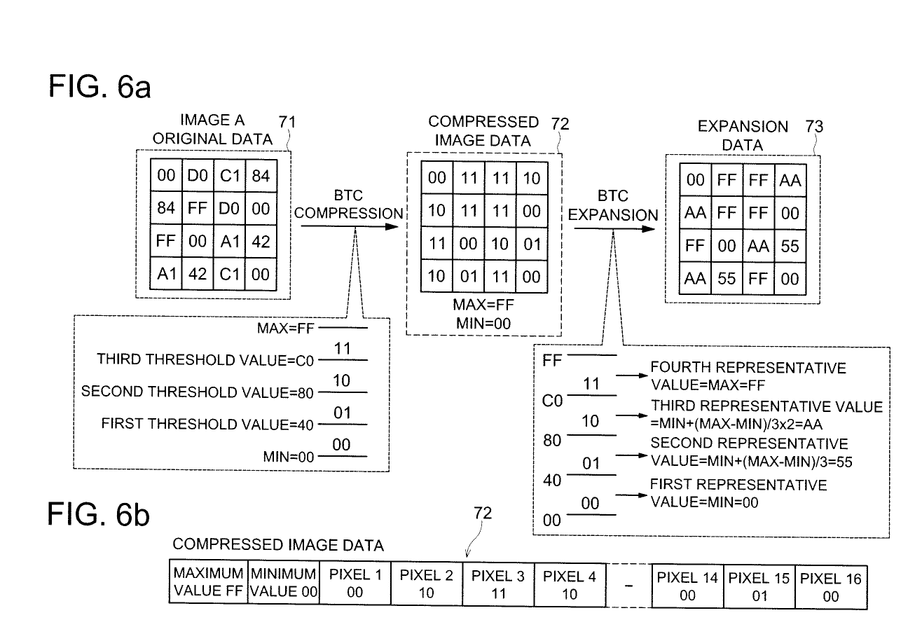

FIG. 6 illustrates an example of a case in which the image compression apparatus 10 compresses the image data (original data 71) of the image A, and the image expansion apparatus 60 expands the compressed image data 72 and converts into the expansion data 73. Since the maximum value (FFh) and the minimum value (00h) of the pixel value within the block are different, the original data 71 of the image A is compressed as the compressed data for every block 40A. The area between the maximum value FFh and the minimum value 00h is divided into four areas by the first threshold value 40h, the second threshold value 80h and the third threshold value C0h. The pixel value D is coded so that the pixel having the maximum value (FFh)≧D>the third threshold value (C0h) is converted to the 2-bit coded data “11”, the pixel having the third threshold value (C0h)≧D>the second threshold value (80h) is converted the code data “10”, the pixel having the second threshold value (80h)≧D>the first threshold value (40h) is converted to the code data “01” and the pixel having the first threshold value (40h)≧D≧the minimum value (0h) is converted to the code data “00”, respectively. As illustrated in the FIG. 6b, the compressed image data 72 is arranged and outputted in the order of the maximum value, the minimum value and the code data of each pixel.

At the time of expansion, since the maximum value and the minimum value at the foremost section of the compressed image data are different, the compressed image data is recognized as the compressed data for every block 40A. Then the expansion process is performed. First, the maximum value FFh is set as the fourth representative value corresponding to the code data “11”, the minimum value 00h is set as the first representative value corresponding to the code data “00”, the bigger AAh of two boundary values that equally divide the range (FFh-00h) that is indicated by these maximum value and minimum value into three is set as the third representative value corresponding to the code data “10” and the smaller 55h of the two boundary values is set as the second representative value corresponding to the code data “01”. The compressed image data is expanded into the expansion data 73 for one block by converting each code data included in the compressed image data 72 into the representative value corresponding to the value of the code data.

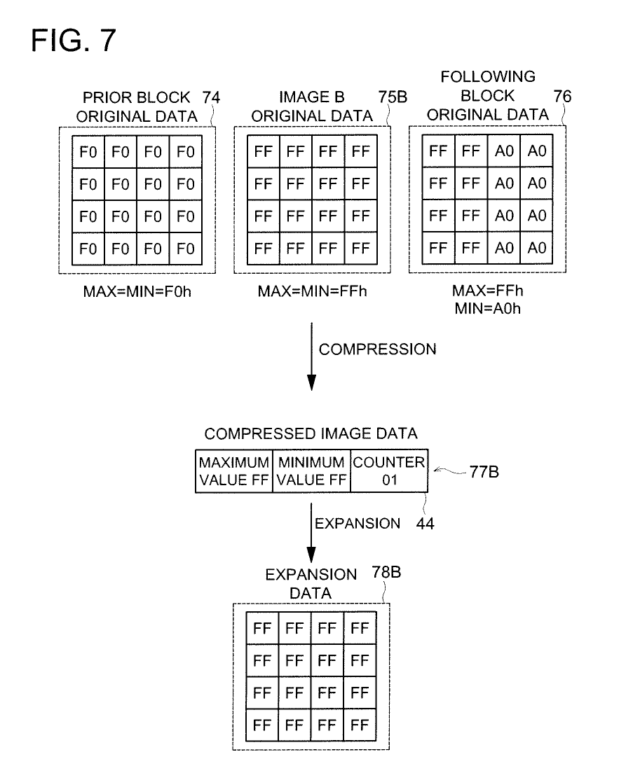

FIG. 7 illustrates an example of a case in which the image data (original data 75B) of the image B is compressed by the image compression apparatus 10, and the compressed image data 77B is expanded and converted into the expansion data 78B by the image expansion apparatus 60. Since the maximum value (FFh) and the minimum value (FFh) of the pixel value within the block are equal to each other, the original data 75B of the image B is compressed as the continuous compressed data 40B. Here, since the image contents of the image B is not the same with the prior block 74 and the following block 76, the number of continuous block becomes “1”. That is, the maximum value=the minimum value in the prior block 74. However, the pixel value is F0h and differs from the pixel value FFh of the image B. The maximum value and the minimum value are not equal to each other in the following block 76. Therefore, the image B is the data format of the continuous compressed data 40B, and is compressed into the compressed image data 77B in which the maximum value=the minimum value=FFh and the count data 44=1.

At the time of expansion, since the maximum value and the minimum value at the foremost of the compressed image data 77B are equal to each other, the compressed image data 77 is recognized as the continuous compressed data 40B. Thus, the expansion process is performed. That is, since the image for one block having the maximum value as the pixel values of all pixel is generated and the number of continuous block indicated by the count data is “1”, the expansion process against the compressed image data 77B is terminated at the point when the image for this one block is outputted as the expansion data 78B.

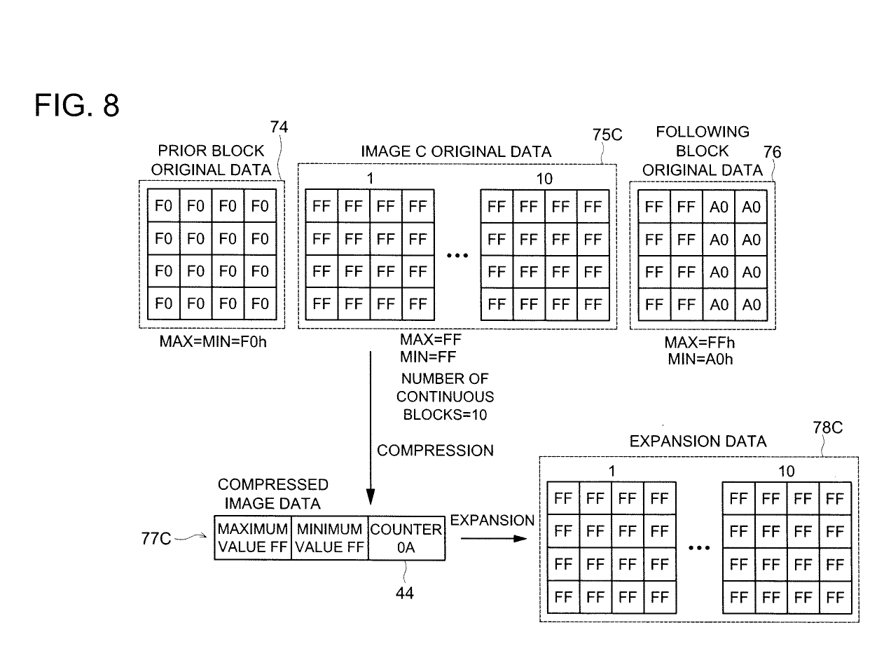

FIG. 8 illustrates an example of a case in which an image C in which ten blocks having the maximum value=the minimum value=FFh continue is compressed and expanded. Since the number of continuous blocks is 10 (A0h), the image C has the data format of the continuous compressed data 40B and the image C is compressed to the compressed image data 77C, which has the maximum value=the minimum value=FFh and the count data 44=A0h. At the time of expansion, since the maximum value and the minimum value at the foremost of the compressed image data 77C are equal to each other, the compressed image data 77C is recognized as the continuous compressed data 40B. Also since the value of the count data 44 is A0h, the block of the pixel values of all pixel FFh is repeatedly outputted for ten times.

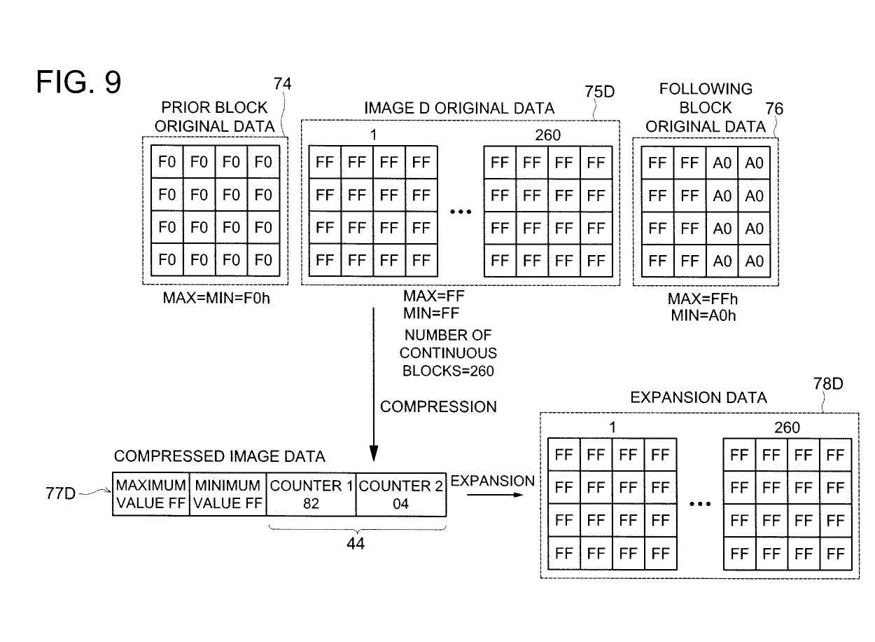

FIG. 9 illustrates an example of a case in which an image D, in which 260 blocks having the maximum value=the minimum value=FFh continue, is compressed and expanded. Since the number of continuous block is 260, the image D has the data format of the continuous compressed data 40B and the image D is compressed to the compressed image data 77D, which has the maximum value=the minimum value=FFh and the count data 44 is 2 byte (82h, 04h). At the time of expansion, since the maximum value and the minimum value at the foremost of the compressed image data 77D are equal to each other, the compressed image data 77D is recognized as the continuous compressed data 40B. Also since the value of the count data 44 configured by 2 bytes is 260, the block having the pixel value of all pixel FFh is repeatedly outputted for 260 times.

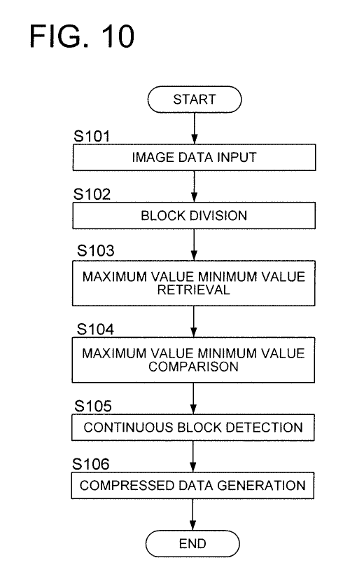

FIG. 10 illustrates a flow of a compression process in the image compression apparatus 10. The image data is inputted (STEP S101). The image data is divided into the images of block units by the block dividing section 11 (STEP S102). The maximum value and minimum value retrieval section 12 retrieves the maximum value and the minimum value of the pixel value in each of the divided blocks (STEP S103).

The continuous compression section 16 compares the retrieved maximum value and minimum value of the present block with those of the block one before the present block (STEP S104). In case when the block having the maximum value=the minimum value is detected, the number of continuation of the block having the same maximum value and the minimum value is counted (STEP S105). The image data of the block for the number of continuation is converted and compressed into the compressed image data in the continuous compressed data 40B format (STEP S106). With respect to the block in which the maximum value and the minimum value are not equal to each other, the normalization section 14 compresses the image data of the block to the compressed image data in the form of the compressed data for every block 40A and outputs the data (STEP S106).

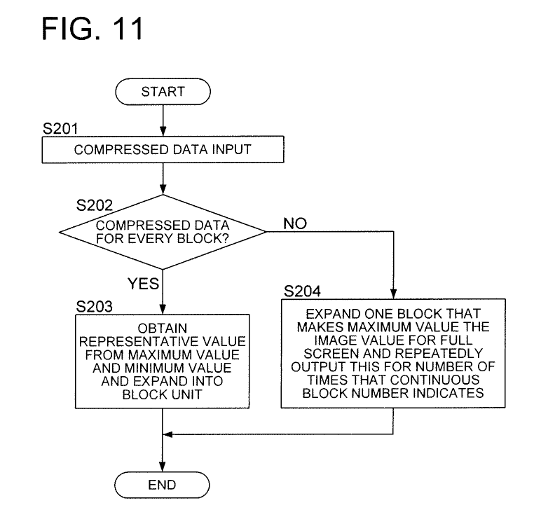

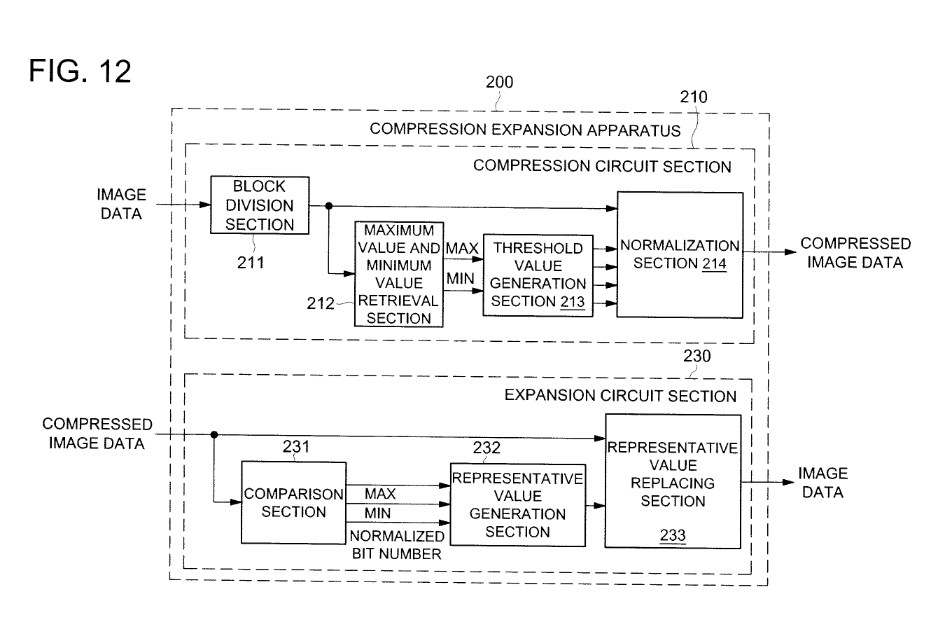

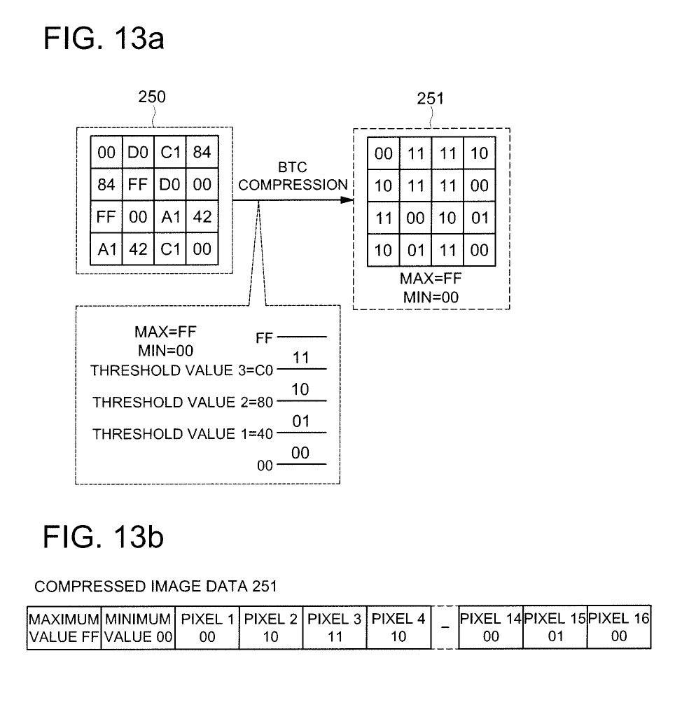

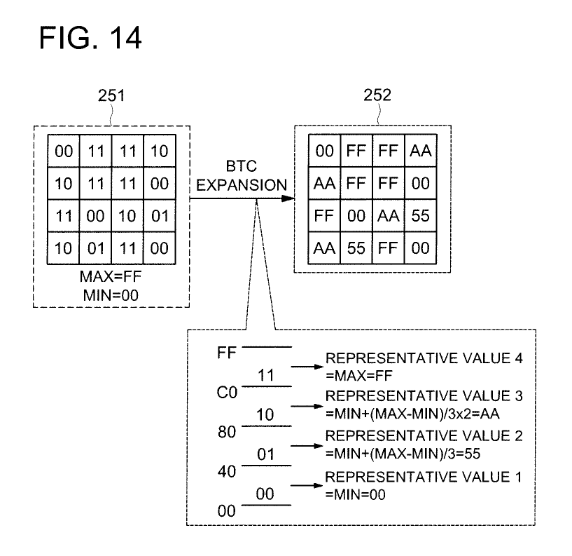

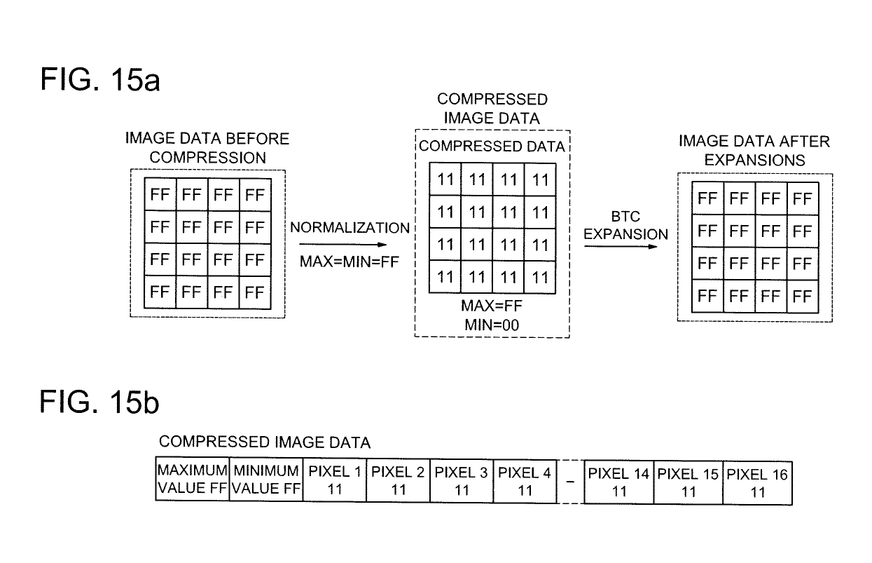

FIG. 11 illustrates a flow of an expansion process in the image expansion apparatus 60. The compressed image data is inputted (STEP S201). Then whether the compressed image data is the compressed data for every block 40A or the continuous compressed data 40B is determined (STEP S202). In case the compressed image data is determined to be the compressed data for every block 40A (STEP S202; Yes), the representative value is generated from the maximum value and the minimum value, each code data is converted to the pixel having the representative value corresponding to each code data as the pixel value, and the data is expanded (STEP S203). In case when the compressed image data is determined to be the continuous compressed data 40B (STEP S202; No), a block having the maximum value as the pixel value of all pixels is generated, and this block is repeatedly outputted for the number of times that is indicated by the count data 44 (STEP S204).

Thus, in case when the block in which the maximum value=the minimum value continues one time or more, these blocks are expressed by the continuous compressed data 40B configured by the maximum value, the minimum value and the number of continuous block. Therefore, in case when the block having the same maximum value and the minimum value as the block of one before continues for two or more times, a compression rate can be increased compared to the case for compressing for every block.

In the embodiment of the present invention, only the case of the maximum value=the minimum value has been targeted. However, in case when the difference of the maximum value and the minimum value is below the reference value, the data may be compressed in the premise that the pixel value within the block is the same for all pixels within the block. For example, the data may be compressed so that a mean value of the maximum value and the minimum value becomes the pixel value of all pixels. In this case, even with respect to the density close to white or medium density, a small difference in the shade is visually hard to notice. However, with respect to the image close to black, the difference in shade is also hard to notice. Therefore, the image compression apparatus and the image expansion apparatus may be arranged to control so to change the reference value corresponding to the density of the image (gradation value). That is, in case when the density of the image (gradation value) is close to black, the image compression apparatus and the image expansion apparatus may be controlled so that the reference value is small compared to the case of white or medium density. For example, in case when each pixel is expressed with 8 bit 256 gradations (O is white and FFh is black), the reference value is set to “7” when the maximum value of the pixel value within the block is not less than A0h, the reference value is set to “3” when the maximum value of the pixel value within the block is less than A0h and not less than 30h, and the reference value is set to “1” when the maximum value of the pixel value within the block is less than 30h.

In addition, with respect to the block whose pixel value has been replaced with the mean value and all pixels within the block is considered to be the same when the difference of the maximum value and the minimum value is not more than the reference value as mentioned above, in case when the replaced mean value is the same with the block that is one before the present block, it is preferable to treat the data as the block of the same image contents continues and to compress the data with the continuous compressed data 40B.

In the above, the embodiment of the present invention has been described in reference to the drawings. However, a concrete configuration is not limited to the above mentioned embodiment of the present invention. A change and an addition that do not depart from the scope of the present invention will be included in the present invention.

For example, in the embodiment of the present invention, the maximum value and the minimum value within a block are detected, and in case when the maximum value=the minimum value, all pixels within the block were considered to have the same pixel value. However, the pixel value of all the pixels may be compared and determined whether the values are the same or not. Only the block whose maximum value=the minimum value has been determined whether the block having the same image contents continues or not. However, whether the pixel value of the pixel corresponds to each of the pixels is determined between blocks. In case when each pixel are determined to have the same pixel value, the image contents of these blocks are considered to be the same and the continuation of those blocks may be determined.

In the embodiment of the present invention, the maximum value and the minimum value have been used as the information that indicates the distribution range of the pixel value for the compressed image data. However, the information that indicates the position and the width of the distribution range may be used. In this case, whether the data format of the data is equivalent to the compressed data for every block 40A or the continuous compressed data 40B may be determined by determining whether the information that indicates the width of the distribution range is “0” or not.

The image compression apparatus 10 and the image expansion apparatus 60 are not limited to the circuit configuration illustrated by the embodiment of the present invention. The image compression apparatus 10 and the image expansion apparatus 60 may be arranged with a different configuration that has the same function. The compression process and the expansion process of the same contents may be realized by executing a predetermined program in a computer paraphernalia configured by a CPU (Central Processing Unit), a ROM (Read Only Memory) and RAM (Random Access Memory).

What is claimed is:

1. An image compression apparatus comprising;
a dividing section for dividing image data to be compressed into a plurality of blocks;
a compression section for compressing in order each block of the plurality of blocks which have been obtained by divided in the dividing section;
wherein the compression section converts the continuing blocks of the same image contents, into basic data and continuous compressed data;
wherein the basic data is a compressed date from any one of the continuing blocks of the same image contents, and
the count data indicates a number of the continuing blocks.

2. The image compression apparatus of claim 1;
wherein the compression section detects the continuing block of the same image contents for the blocks in each of which all pixels have the same pixel values.

3. An image expansion apparatus expanding compressed data which has been compressed in order each block of a plurality of blocks obtained by dividing image data, and which has been converted into continuous compressed data containing a basic data which is a compressed date from any one of continuing blocks of the same image contents and a count data indicating a number of continuing blocks, and comprising;
a detection section detecting the continuous compressed data;
a repeat output section expanding the basic data of the continuous compressed data detected by the detecting section into one block of image data, and repeating output of the one block of the image data the same number of times as the number of the continuing blocks indicated by the count data.

4. The image expansion apparatus of claim 3;
wherein the continuing blocks of the same image contents are the blocks in each of which all pixels have the same pixel value.
